(19) United States
(12) Patent Application Publication
(10) Pub. No.: US 2007/0234131 A1
(43) Pub. Date: Oct. 4, 2007

(54) Server inspecting method and system

(75) Inventor: Wen-Hsin Ho, Taipei (TW)

Correspondence Address: EDWARDS ANGELL PALMER & DODGE LLP, P.O. BOX 55874, BOSTON, MA, 02205, US

(73) Assignee: Inventec Corporation, Taipei (TW)

(21) Appl. No.: 11/396,045

(22) Filed: Mar. 30, 2006

(51) Int. Cl. G06F 11/00

(52) U.S. Cl. 714/43; 714/25

(57) ABSTRACT

A server inspecting method and system for inspecting a module to be inspected of a server is disclosed. This provides a time-saving and labor-saving inspecting method for users, and reduces the consumption of human resources and improves the working efficiency of inspecting personnel. Moreover, the system and method can further completely record inspecting data of servers in various models, allowing the inspecting personnel to find problems when any abnormality is found.

### BACKGROUND OF THE INVENTION

1. Field of the Invention

This invention relates to automatically analyzing inspecting and testing methods, and more particularly, to a server inspecting method for inspecting inspect modules of a server.

2. Description of Related Art

With the fast development of information technologies, network services are becoming a primary way for people to acquire data and information. Take a modem network service as an example. The modem network service is integrated with a variety of functions, for users to operate easily. Accordingly, varieties of servers of this type are brought to the market. How to provide a good hardware system to consumers is becoming one of the most important issues for server manufactures. The issue has a close relation with a manufacturing yield factor, and the determination of the manufacturing yield factor is achieved through inspecting works. Therefore, before the servers leave the factory, the inspecting works has to be prudently performed and becomes a time-consuming and labor-consuming work. In a circumstance that a number of demands for servers grows rapidly, to achieve an effect of increasing the output of servers, more labors are devoted to inspect the servers. Because inspecting results and problems have to be judged by inspecting personnel, how to save time, labor and material resources on judging the inspecting results is becoming one of the most important issues for manufacturers currently.

In order to solve the above problems and improve efficiency of operation, an inspecting quality control procedure optimization method is used to improve its inspecting efficiency. The method simplifies the works, which are judged by professional inspecting engineers originally, to systematic input inspecting procedures and simplified output information, and gives comparing works of the output information to operators. The operators determines if execution results are correct by comparing contents listed in an operation guide book, and decides whether or not to execute a next process. However, in the inspecting process, the operators have to input a lot of instructions repeatedly and check if returned information are correct, so the method still needs many labor to execute such the repetition work, though the time and labor consumed on the inspecting judgment are saved.

Therefore, how to provide a method capable of solving the drawbacks of the prior art and allowing manufacturers easier to analyze, inspect and test hardware and functions provided by the manufacturers is becoming one of the most important issues in the art.

### SUMMARY OF THE INVENTION

In views of the above-mentioned problems of the prior art, it is a primary objective of the present invention to provide a server inspecting method and system applicable to server in varieties models and having different functions.

It is another objective of the present invention to provide a server inspecting method and system, without the need to re-design an inspecting method and operation steps for the servers in different models individually.

It is a further objective of the present invention to provide a server inspecting method and system for recording inspecting results automatically. To achieve the above-mentioned and other objectives, a server inspecting method and system is provided according to the present invention. The server inspecting method is used for inspecting a module to be inspected (hereinafter also referred to as “inspect module”) of a server. The server inspecting method includes the following steps: (1) providing an input module for inputting input data; (2) providing an inspecting module having a database and a memory unit for comparing the input data with batch files stored in the database and searching for a batch file corresponding to the input data; (3) executing inspecting instructions of the searched batch file automatically; (4) selecting a communication interface module for connecting between the inspect module and the inspecting module, and defining a master-slave relation of the inspect module and the inspecting module; (5) starting to execute inspecting function items of the inspect module based on the inspecting instructions of the batch file; and (6) providing a display module for displaying inspecting results of the inspect module.

The present invention further provides another server inspecting method for inspecting inspect modules of a server. The server inspecting method includes the following steps: (1) providing an input module for inputting input data; (2) providing an inspecting module having a database and a memory unit for comparing the input data with batch files stored in the database and searching for a batch file corresponding to the input data; (3) Executing inspecting instructions of the searched batch file automatically; (4) selecting a communication interface module for connecting the inspect module and the inspecting module, and defining a master-slave relation of the inspect module and the inspecting module; (5) starting to execute inspecting function items of the inspect module based on the inspecting instructions of the batch file, and storing sequence data in the memory unit when data returned by the inspecting function items are the sequence data; (6) providing a sequence data of the inspecting instructions for comparing with the sequence data stored in the memory unit; and (7) providing a display module and a storage module for displaying inspecting results of the inspect module, and storing the inspecting results in the storage module.

The server inspecting system is used for inspecting inspect modules of a server. The server inspecting system includes an input module for inputting input data; an inspecting module having a database and a memory unit, the database being used for comparing the input data and providing a batch file corresponding to the input data, and executing inspection on the inspect module based on inspecting function items of the batch file; a communication interface module for performing command and data transmission on the inspecting module and the inspect module; a display module for displaying inspecting results of the inspecting function items; and a storage module for storing the inspecting results of the inspecting function items.

Moreover, the present invention provides a time-saving and labor-saving inspecting method for inspecting personnel, so as to reduce the consumption of human resources and improve the working efficiency of the inspecting personnel. The present invention can further completely record inspecting data of servers in varieties models, allowing the inspecting personnel to find problems when any abnormality is found.

### BRIEF DESCRIPTION OF DRAWINGS

The invention can be more fully understood by reading the following detailed description of the preferred embodiments, with reference made to the accompanying drawings, wherein:

FIG. 1 is a flow chart of a server inspecting method of a first embodiment according to the present invention;

FIG. 2 is a functional block diagram of a server inspecting system corresponding to the server inspecting method shown in FIG. 1; and

FIG. 3 is a flow chart of a server inspecting method of a second embodiment according to the present invention.

### DETAILED DESCRIPTION OF PREFERRED EMBODIMENTS

The following illustrative embodiments are provided to illustrate the disclosure of the present invention, these and other advantages and effects can be apparently understood by those in the art after reading the disclosure of this specification. The present invention can also be performed or applied by other different embodiments. The details of the specification may be on the basis of different points and applications, and numerous modifications and variations can be devised without departing from the spirit of the present invention.

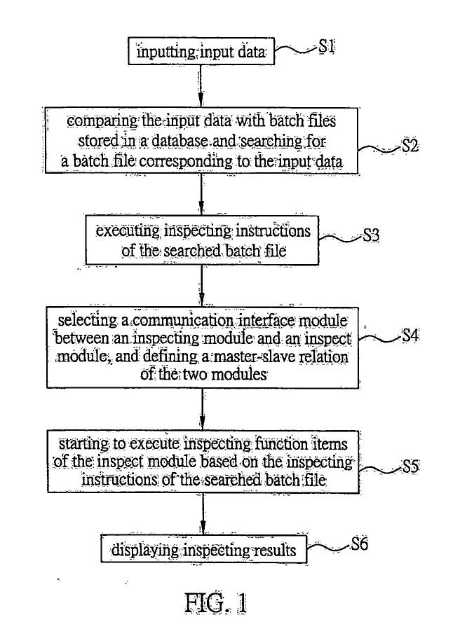

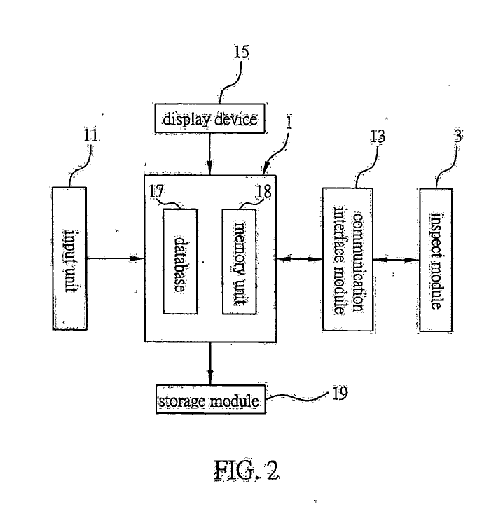

FIG. 1 is a flow chart of a server inspecting method of a first embodiment according to the present invention. FIG. 2 is a functional block diagram of a server inspecting system corresponding to the server inspecting method shown in FIG. 1. The server inspecting system is used for inspecting a server and recording inspection messages of the server. The method starts in step S1.

In step S1, the method utilizes an input unit 11 (for example, a computer keyboard, a barcode reader and buttons having input instructions) to input input data to an inspecting module 1. According to the first embodiment, the input data is a machine code, a serial number, a media access control (MAC) address or a barcode of an inspect module 3 ready to be inspected by the server inspecting system. The method then proceeds to step S2.

In step S2, the method compares the input data with batch files stored in a database 17 of the inspecting module 1 to search for one of the batch files corresponding to the input data. The method proceeds to step S3.

In step S3, the method executes inspecting instructions of the searched batch file. The method proceeds to step S4.

In step S4, the method selects a communication interface module 13 used between the inspect module 3 and the inspecting module 1 for performing data transmission and inspection steps, and defines a master-slave relation between the inspect module 3 and the inspecting module 1. The method proceeds to step S5.

In step S5, the method starts to execute inspecting function items of the inspect module 3 automatically based on the inspecting instructions of the searched batch file. The method proceeds to step S6.

In step S6, the method utilizes a display device 15 to display a plurality of inspecting results of the inspect module 3. According to the first embodiment, the display device 15 is a display or a light.

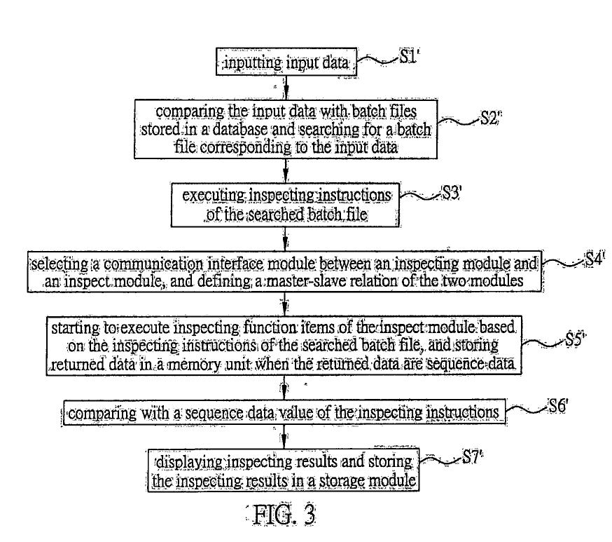

FIG. 3 is a flow chart of a server inspecting method of a second embodiment according to the present invention. The method starts in step S1′.

In step S1′, the method utilizes the input unit 11 to input input data to the inspecting module 1. According to the second embodiment, the input data is a machine code, a serial number, a MAC address or a barcode of the inspect module 3. The method proceeds to step S2′.

In step S2′, the method compares the input data with the batch files stored in the database 17 of the inspecting module 1 to search for one of the batch files corresponding to the input data. The method proceeds to step S3′.

In step S3′, the method executes inspecting instructions of the searched batch file. The method proceeds to step S4′.

In step S4′, the method selects the communication interface module 13 used between the inspect module 3 and the inspecting module 1 for performing the data transmission and inspection steps, and defines a master-slave relation between the inspect module 3 and the inspecting module 1. The method proceeds to step S5′.

In step S5′, the method starts to execute inspecting function items of the inspect module 3 automatically based on the inspecting instructions of the searched batch file, and stores sequence data in a memory unit 18 if inspected or returned data is the sequence data. The method proceeds to step S6′.

In step S6′, the method compares the sequence data stored in the memory unit 18 with values of sequence data of the inspecting instructions. The method proceeds to step S7′.

In step S7′, the method utilizes the display device 15 to display inspecting results of the inspect module 3, and stores the inspecting results in a storage module 19 of the inspecting module 1.

Compared with the prior art, the server inspecting system and method make the use of a database retrieving method to search for a batch file corresponding to input data (for example a model of a server) selected by a user. The present invention can further change inspecting instructions of the searched batch file, to flexibly adjust and arrange functions to be inspected and order. The present invention further displays server inspecting results on a display device. Therefore, through the use of the server inspecting system and method of the present invention, a user is easily to inspect a server and determines whether returned messages indicate that inspecting functions are normal, without the need to refer to indications listed in an operation guide book any more.

Moreover, the present invention provides a time-saving and labor-saving inspecting method for inspecting personnel, so as to reduce the consumption of human resources and improve the working efficiency of the inspecting personnel. The present invention can further completely record inspecting data of servers in varieties models, allowing the inspecting personnel to find problems when any abnormality is found.

The foregoing descriptions of the detailed embodiments are only illustrated to disclose the features and functions of the present invention and not restrictive of the scope of the present invention. It should be understood to those in the art that all modifications and variations according to the spirit and principle in the disclosure of the present invention should fall within the scope of the appended claims.

What is claimed is:

1. A server inspecting method for inspecting a module to be inspected of a server, the server inspecting method comprising the steps of:
(1) providing an input module for inputting input data;
(2) providing an inspecting module having a database and a memory unit, for comparing the input data with batch files stored in the database and searching for one of the batch files corresponding to the input data;
(3) executing inspecting instructions of the searched batch file automatically;
(4) selecting a communication interface module for connecting the module to be inspected and the inspecting module to each other, and defining a master-slave relation of the module to be inspected and the inspecting module;
(5) starting to execute inspecting function items of the module to be inspected based on the inspecting instructions of the batch file; and
(6) providing a display module for displaying inspecting results of the module to be inspected.

2. The server inspecting method of claim 1, wherein the communication interface module is provided for the inspecting module and the module to be inspected to perform commands and data transmission.

3. The server inspecting method of claim 1, wherein the display module is one selected from the group consisting of a display, a light and a beeper.

4. A server inspecting method for inspecting a module to be inspected of a server, the server inspecting method comprising the steps of:
(1) providing an input module for inputting input data;
(2) providing an inspecting module having a database and a memory unit, for comparing the input data with batch files stored in the database and searching for one of the batch files corresponding to the input data;
(3) executing inspecting instructions of the searched batch file automatically;
(4) selecting a communication interface module for connecting the module to be inspected and the inspecting module to each other, and defining a master-slave relation of the module to be inspected and the inspecting module;
(5) starting to execute inspecting function items of the module to be inspected based on the inspecting instructions of the batch file, and when data returned by the inspecting function items are sequence data, storing the sequence data in the memory unit;
(6) providing sequence data of the inspecting instructions to be compared with the sequence data stored in the memory unit; and
(7) providing a display module and a storage module for displaying inspecting results of the module to be inspected, and storing the inspecting results in the storage module, respectively.

5. The server inspecting method of claim 4, wherein the communication interface module is provided for the inspecting module and the module to be inspected to perform commands and data transmission.

6. The server inspecting method of claim 4, wherein the display device is one selected from the group consisting of a display, a light and a beeper.

7. A server inspecting system for inspecting a module to be inspected of a server, the server inspecting system comprising:
an input module for inputting input data;
an inspecting module having a database and a memory unit, the database for comparing the input data and providing a batch file corresponding to the input data, and the inspecting module for executing inspection on inspecting function items of the module to be inspected based on the batch file;
a communication interface module for performing commands and data transmission on the inspecting module and the module to be inspected;
a display module for displaying inspecting results of the inspecting function items; and
a storage module for storing the inspecting results of the inspecting function items.

8. The server inspecting system of claim 7, wherein the display module is one selected from the group consisting of a display, a light and a beeper.
